(19) United States
(12) Patent Application Publication
(10) Pub. No.: US 2022/0214146 A1
(43) Pub. Date: Jul. 7, 2022

(54) ENTANGLEMENT DEVICE AND METHOD OF USE

(71) Applicant: The Secretary of State for Defence, Salisbury, Wiltshire (GB)

(72) Inventor: Nicholas Morton, Salisbury, Wiltshire (GB)

(21) Appl. No.: 17/601,883

(22) PCT Filed: Apr. 2, 2020
(86) PCT No.: PCT/GB2020/000041

§ 371 Date: Oct. 6, 2021

(30) Foreign Application Priority Data
Apr. 11, 2019 (GB) 1905128.3

(51) Int. Cl. F41H 13/00; B64C 39/02; B64D 1/02; F41H 11/02; F42B 12/68

(52) U.S. Cl. CPC F41H 13/0006; B64C 39/024; B64D 1/02; B64C 2201/182; F42B 12/68; B64C 2201/12; F41H 11/02

(57) ABSTRACT

An entanglement device (50) has multiple elongate filaments (53) attached together to form a tassel. The entanglement device (50) is of particular use for disabling the propellers (52) of a nuisance airborne drone. When deployed, the filaments (53) spread apart over a relatively wide area before being pulled into the drone's propellers (52), wrapping around them and forcing the drone to land. Also included is a method of disabling a propeller (52) of a drone.

### TECHNICAL FIELD OF THE INVENTION

This invention relates to the field of entanglement devices, and more particularly to entanglement devices that are suitable for disabling propellers of airborne drones.

### BACKGROUND TO THE INVENTION

Drones are remotely controlled airborne vehicles that typically comprise one or more propellers to generate lift and impart, motion. Drones are increasingly used for recreational purposes, but also can be used for remote operations and surveillance. Despite drone use being subject to legal restrictions in some nations—in particular when used in proximity to certain locations (for instance airports)—this has not entirely prevented illegal drone activity. Therefore ‘anti-drone’ or ‘drone control’ measures have been developed in an effort to mitigate illegal or nuisance drone use.

The majority of anti-drone techniques and equipment have focused on interrupting the wireless communications of drones. More generally referred to as drone ‘jamming’ this aims at disrupting the communications sent between a drone user (operating a remote control) and the drone itself. An example of such a prior art technique is provided in US20180069650A1. More advanced jamming techniques can offer some drone control, and potentially safe landing of a nuisance drone for subsequent removal. However such techniques generally require advance knowledge of the type of drone being targeted, in order to tailor the jamming effect. This knowledge may not be readily available in emergency situations.

A number of physical control techniques have also been developed that can be more generally applied to nuisance or illegal drone activity. One such technique is disclosed in U.S. Ser. No. 10/040,554 wherein a set of antennas are used to cue a gun to shoot down a nuisance drone. This approach requires high accuracy tracking of the drone, which may itself be exercising evasive manoeuvres. However in urban regions such a technique is unlikely to be used, owing to the risk of firing bullets or other ballistic weaponry towards or over populated areas.

An alternative physical control technique utilises entanglement of a propeller to disable a nuisance drone. Entanglement can occur when a thread or strand of material wraps around a propeller rotor or indeed the propeller itself. This resists the rotation of the propeller and causes either partial or complete failure. An example of a propeller inhibiting strand for use with drones is disclosed in US20170219317A1, and comprises an elongate filament with a mass at one end. The strand may be dropped into a drone propeller in an attempt to cause entanglement and mechanical failure of the drone. However such a strand can be readily knocked away from the drone by the propeller without having caused an entangling effect.

Therefore it is an aim of the present invention to provide an alternative entanglement device for disabling a propeller of an airborne drone.

### SUMMARY OF THE INVENTION

According to a first aspect of the invention there is provided an entanglement device for disabling a propeller of an airborne drone, the entanglement device comprising a plurality of filaments attached together to form a tassel. Prior art entanglement devices are limited to single filaments which can be readily knocked away from a propeller as the propeller rotates, reducing the reliability of the device. By providing a plurality of filaments arranged as a tassel, as the entanglement device is deployed, the filaments spread apart but remain attached to provide a relatively larger area for engagement. Furthermore as one filament is knocked away from a propeller, the remaining filaments are resultantly pulled into the propeller. The inventor has shown this improves the reliability of the entanglement device in entangling a propeller and thereby disabling a drone.

Drones comprise propellers for generating lift and imparting motion. Entangling a propeller comprises wrapping a filament or plurality of filaments around at least the propeller (the blades, propeller shaft or respective motor shaft for instance) in order to severely disrupt the rotation of the propeller. Disruption of the propeller must be sufficient to disable a drone. This may mean severely affecting the drone's ability to manoeuvre, or reducing the ability of the drone to generate lift such that it is forced to land or impact the ground.

The term ‘filament’ is intended to mean an elongate threadlike object, fibre, string or ribbon. The entanglement device comprises a plurality of such filaments attached together as a tassel. The term ‘tassel’ is intended to mean that the filaments are attached together at a common point such that each filament has at least one free or loose end. The attachment is preferably in the form of a knot for relatively simple manufacture, however other forms of attachment may be used such as heat fusing or gluing.

In preferred embodiments the filaments are attached at respective closed ends such that each filament has only one free end. Each filament has two ends—in these embodiments one end of each filament is commonly joined together with the other filaments such that the respective ends are closed (not free to move or loose). This maximises the amount of the length of each filament that is available for entanglement.

Preferably the plurality of filaments comprises at least three filaments. Three filaments attached as a tassel can be considered as the minimum number of filaments required to define a volume with their respective free ends. This increases the volumetric coverage of a single entanglement device, increasing the likelihood of a propeller being intercepted by the device.

In some embodiments the filaments have a length of less than or equal to 50 cm. Recreational drones vary in physical size, but typically have a frame size of less than 50 cm. A drone may comprise a plurality of propellers located within, or at the periphery, of the overall frame size. It is preferable to provide a filament length that at least matches the frame size of the drone being targeted, to increase the likelihood of at least one propeller, preferably two propellers, becoming entangled.

Preferably the filaments of the entanglement device are formed from a woven fabric such as a ripstop fabric. This increases the resistance of the filaments to tearing and ripping when being impacted by the blades of a propeller. It may be preferred to allow the filaments to tear along their length in use, so as to effectively increase the number of filaments available for entanglement. In these scenarios the woven fabric may have greater resistance to tearing along the length of the filaments than across their width. Alternatively the resistance to tearing and ripping may be similar across both the width and length of the filaments. In these embodiments a woven fabric with crosshatched reinforcement threads may be used, as is present in ripstop materials.

Even more preferable is that the woven fabric is ripstop nylon. Ripstop nylon is a lightweight ripstop fabric that has a low porosity. This ensures the filaments after deployment present an increased air resistance, causing them to float or loiter in the proximity of a drone, rather than immediately fall away from its vicinity. Furthermore, ripstop nylon is fire resistant allowing deployment using explosive means (for instance airburst projectiles) with reduced risk of fire damage.

According to a second aspect of the invention there is provided an airborne drone disablement apparatus, comprising the entanglement device of any preceding claim, and an intercept vehicle for transporting and deploying the entanglement device towards a propeller of an airborne drone. This provides a physical disablement mechanism for drones partaking in nuisance or illegal activities, wherein the entanglement device itself has increased reliability in comparison to the prior art. Furthermore a plurality of entanglement devices may be transported and deployed to generate a debris field that may be used to intercept a drone swarm.

An ‘intercept vehicle’ is used to deliver a payload to a target location, such that the payload can be deployed at the target location. Therefore the intercept vehicle must retain the entanglement device until the point of deployment. In some embodiments the intercept vehicle is another intercept drone which carries one or more of the entanglement devices to a nuisance drone. For instance an intercept drone may track and fly towards a nuisance drone and position itself above the nuisance drone. The entanglement device/s may then be dropped from the intercept drone into the propeller/s of the nuisance drone. Alternatively the intercept vehicle may be a projectile. The projectile may contain the entanglement device/s and be launched to a target, at which time the entanglement device/s can be deployed (by explosive or some other urging means). Advantageously in these embodiments the projectile can be manufactured to be compatible with already existing launchers. Even more preferred is that the drone disablement apparatus comprises a launcher for launching the projectile.

According to a third aspect of the invention there is provided the use of an entanglement device to disable a propeller of an airborne drone, wherein the entanglement device comprises a plurality of elongate filaments arranged as a tassel. The use of an entanglement device comprising a tassel of filaments increases the likelihood of the entanglement device contacting a propeller of a drone, and furthermore increases the ability of the device to effectively disable a drone.

According to a fourth aspect of the invention, there is provided a method of disabling a propeller of an airborne drone, the method comprising the steps of: transporting to an airborne drone, an entanglement device comprising a plurality of elongate filaments arranged as a tassel; and then deploying the entanglement device at a propeller of the airborne drone; such that the propeller can be entangled, thereby disabling the airborne drone. The method provides a means for physically disabling a drone by introducing an entanglement device into a propeller of the drone, the entanglement device providing a large, area for engagement and therefore an increased likelihood of both contact with and entanglement of a drone propeller. Deploying the entanglement device at a propeller includes deployment in the vicinity of the propeller such that entanglement can occur. Furthermore, an area effect may be achieved by transporting and deploying a plurality of entanglement devices. The plurality of devices may loiter in and move with the air mass in the vicinity of a drone. This creates a large pattern of debris increasing the opportunity for successful engagement with a drone. The entanglement devices may have different configurations (masses, lengths, widths, number of filaments) in order to have different deployment effects (some devices may fall faster than others, or be more susceptible to movement in an air stream, for instance).

Whilst additional masses may be attached to the tassel to aid deployment, too much additional mass may cause the tassel to fall in a streamlined configuration, reducing the spatial coverage of the tassel, decreasing the likelihood of the tassel intercepting a drone propeller.

### BRIEF DESCRIPTION OF THE DRAWINGS

Embodiments of the invention will now be described by way of example only and with reference to the accompanying drawings, in which:

FIG. 1 illustrates an embodiment of an entanglement device in a deployed configuration;

FIG. 2 illustrates an embodiment of an entanglement device in a packaged configuration;

FIG. 3a illustrates an embodiment of a drone disablement apparatus being initiated;

FIG. 3b illustrates an intercept vehicle being launched from the apparatus of FIG. 3a;

FIG. 3c illustrates a plurality of entanglement devices being deployed from the intercept vehicle of FIGS. 3a-3b;

FIG. 3d illustrates the plurality of entanglement devices of FIG. 3c in an air mass;

FIG. 4 illustrates an alternative drone disablement apparatus;

FIG. 5a illustrates an embodiment of an entanglement device above a drone propeller;

FIG. 5b illustrates the embodiment of FIG. 5a entering the drone propeller; and

FIG. 5c illustrates the drone propeller of FIGS. 5a and 5b disabled by entanglement.

### DETAILED DESCRIPTION

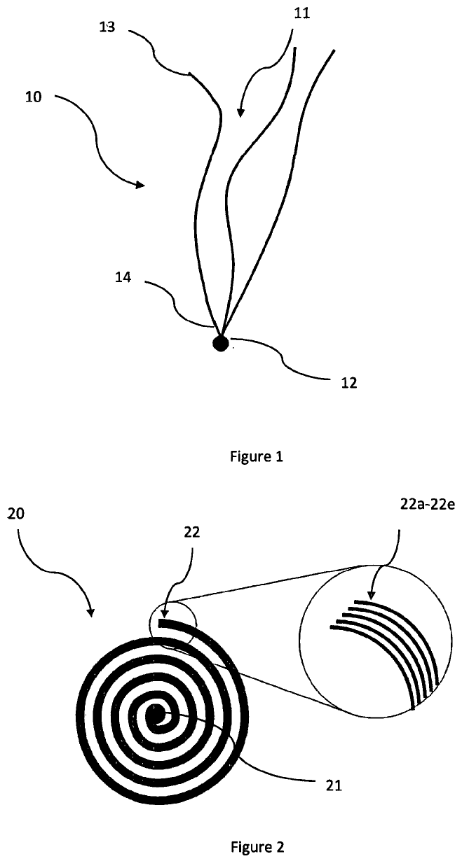

FIG. 1 illustrates an embodiment of an entanglement device 10 in a deployed configuration. The entanglement device 10 comprises three filaments 11. The filaments 11 are elongate and are shown having their upper ends as free ends 13 that may separate and move independently of each other. The filaments 11 are also shown as having their lower ends as closed ends 14 that are attached to each other. The closed ends 14 are attached using knot 12 such that the filaments 11 form a tassel. The filaments 11 and knot 12 are formed as a ribbon from ripstop nylon so as to fall slowly through an air mass once deployed.

FIG. 2 illustrates an embodiment of an entanglement device 20 in a packaged configuration. The filaments 22 of the entanglement device 20 are attached using a knot 21 to form a tassel. The filaments 22 are formed as a ribbon and are coiled around the knot 21 to form a closely packed spiral. An exploded view of filaments 22 is shown in the figure to illustrate that individual filaments 22a-22e themselves are overlaid radially upon each other, and then coiled around knot 21. A plurality of packaged entanglement devices 20 can be subsequently stacked on top of each other inside a canister ready for deployment.

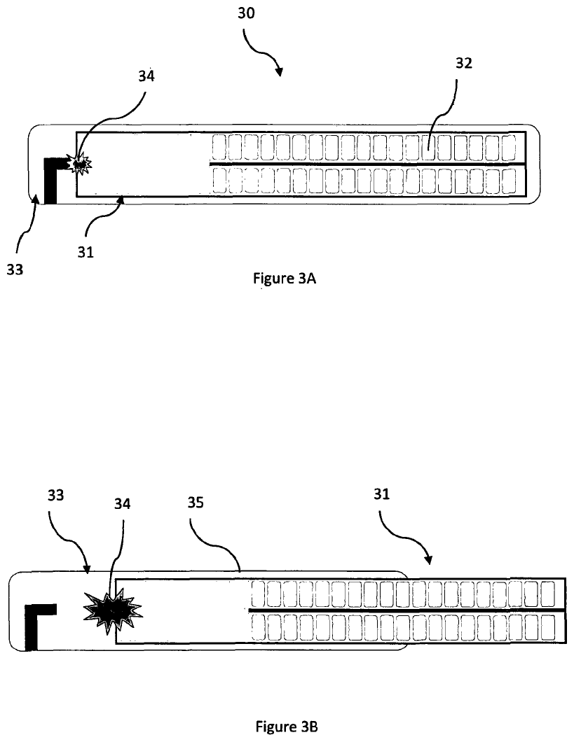

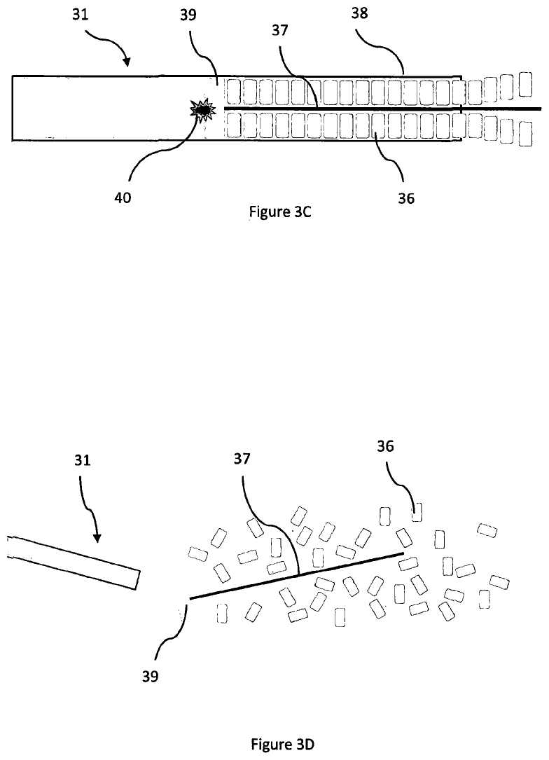

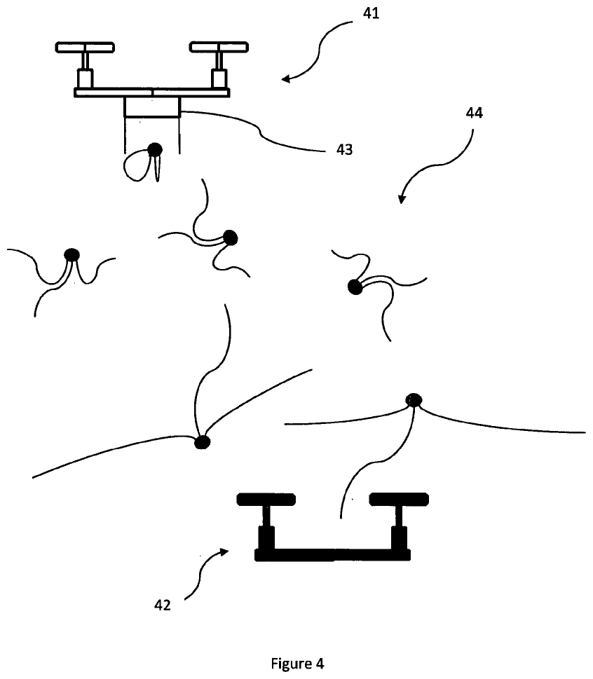

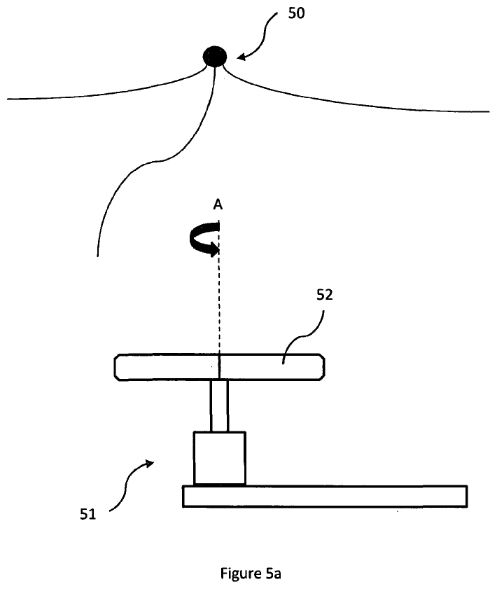

FIG. 3a illustrates an embodiment of a drone disablement apparatus 30 being initiated. The apparatus 30 is shown in cross sectional view and comprises an intercept vehicle 31 inside a launcher 33. The intercept vehicle 31 is a hollow tubular projectile and contains a plurality of entanglement devices 32 arranged adjacent each other. The projectile 31 may be formed from a hardened plastic or thin metal (for instance steel). The projectile 31 is arranged inside a tubular launcher 33. An ejection device 34 arranged adjacent one end of the projectile 31 is illustrated as having been initiated. The ejection device 34 is an explosive charge that is configured when detonated to propel the projectile 31 from the launcher 33.

FIG. 3b illustrates an intercept vehicle 31 being launched from the apparatus of FIG. 3a. The projectile intercept vehicle 31 is shown with the launcher 33 in cross sectional view. The intercept vehicle 31 has been urged from the launch tube 35 of launcher 33 by action of high pressure propellant gases generated from the detonation of explosive in ejection device 34.

FIG. 3c illustrates a plurality of entanglement devices 36 being deployed from the intercept vehicle 31 of FIGS. 3a-3b. The projectile intercept vehicle 31 is shown in cross sectional view and is positioned in an air mass. A tubular casing 38 of the projectile 31 is shown containing a pusher plate 39 attached to a concentric rod 37. The entanglement devices 36 are positioned at locations around the concentric rod 37 and stacked adjacent each other along the length of the rod 37. A secondary ejection device in the form of an explosive charge 40 is indicated as having been initiated. Propellant gases have urged the pusher plate 39 and attached rod 37 along the tubular casing 38 of projectile 31. This has forced entanglement devices 36 from the casing 38.

FIG. 3d illustrates the plurality of entanglement devices 36 of FIG. 3c in an air mass. The entanglement devices 36 have separated from each other to cover a large spatial area. The entanglement devices 36 are shown as still being in a packaged configuration. Interaction with the air mass will cause unpacking of the entanglement devices 36 and their further separation, such that their volumetric coverage further increases. This generates a debris field that can be used to intercept a drone. The projectile intercept vehicle 31 and rod 37 and pusher plate 39 are now redundant and are shown separately falling away from the entanglement devices 36.

FIG. 4 illustrates an alternative drone disablement apparatus. The intercept vehicle 41 is shown as an intercept drone positioned above a nuisance drone 42. The intercept drone 41 has carried a plurality of entanglement devices 44 inside a housing 43 to its current position. The housing 43 has been opened to deploy the entanglement devices 44 above the nuisance drone 42. The figure illustrates entanglement devices 44 falling from the housing 43 and gradually unfurling to provide a large volumetric coverage of the air mass above the nuisance drone 42. The entanglement devices 44 will intercept the nuisance drone 42 by falling into and entangling the propellers to cause disablement.

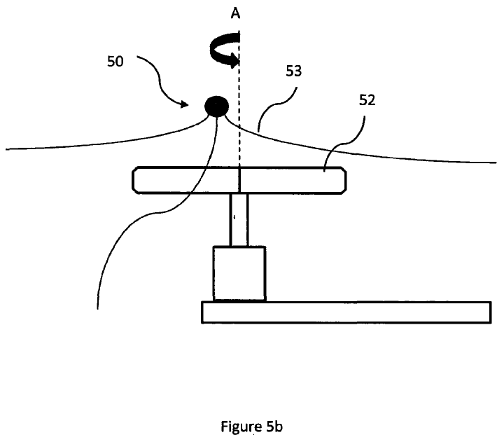

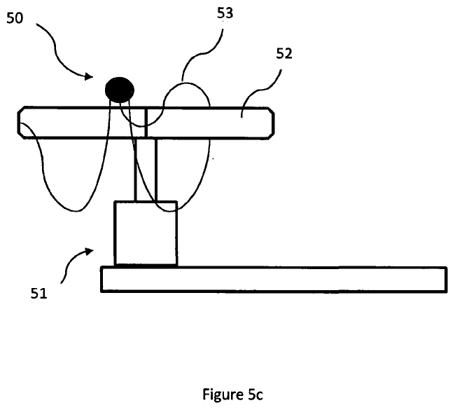

FIG. 5a-5c will now be described as an example of how a drone propeller may become entangled. FIG. 5a illustrates an embodiment of an entanglement device 50 above a drone propulsion system 51. In particular the drone propulsion system 51 comprises a propeller 52 that rotates about axis ‘A’. The entanglement device 50 is spatially large relative to the drone propeller 52 and falls under gravity through an air mass towards the propeller 52. FIG. 5b illustrates the entanglement device 50 of FIG. 5a entering the region immediate to the drone propeller 52. The drone propeller 52 is still rotating about axis ‘A’. The filaments 53 of entanglement device 50 are impacted by the rotating propeller 52. The filaments 53 do not shear or rip owing to their robust material composition—in this embodiment ripstop nylon. As the individual filaments 53 are knocked by the propeller 52, the remaining filaments 53 are drawn into the propeller 52 by virtue of the tassel arrangement. The filaments 53 begin to wrap around the propeller 52. Finally FIG. 5c illustrates the drone propulsion system 51 of FIGS. 5a and 5b disabled by entanglement. The filaments 53 of entanglement device 50 have wrapped around propeller 52 so as to entangle the propeller 52 and stop rotation. The resultant reduction in lift or maneuverability of a drone allows it to be more readily captured or damaged by ground impact.

Whilst the ejection devices shown for launching projectile intercept vehicles, or deploying entanglement devices, are illustrated as explosive, this is not intended to be limiting. Other ejection devices 34 may be used such as gas propulsion. It is preferable for an entanglement device to comprise at least three filaments, but more may be used. Some drone propellers may be provided in a perforated housing or protected by a gridded structure that mitigates propeller damage whilst still allowing airflow. In these scenarios an entanglement device with filaments sized to pass through the perforations or grid apertures will be required. Fine diameter filaments such as Kevlar fibre may optionally be used, but may be difficult to arrange as a tassel using a knot. Therefore for some materials such as Kevlar, alternative attachment methods may be more appropriate such as gluing or heat fusing, so as to form the tassel arrangement. Narrow diameter fibres may also work into the propeller drive shaft housing to achieve further entanglement benefits. The entanglement devices may descend through an air mass with either their tasselled end (for instance knotted end) first, or alternatively may descend with their free ends first.

1. An entanglement device for disabling a propeller of an airborne drone, the entanglement device comprising a plurality of filaments attached together to form a tassel.

2. The entanglement device of claim 1, wherein the filaments are knotted together to form the tassel.

3. The entanglement device of claim 1, wherein the filaments are attached together at respective closed ends such that each filament has only one free end.

4. The entanglement device of claim 1, comprising at least three filaments.

5. The entanglement device of claim 1, wherein each filament has a length of less than or equal to 50 cm.

6. The entanglement device of claim 1, wherein the filaments are formed from a woven fabric.

7. The entanglement device of claim 6, wherein the woven fabric is rip stop nylon.

8. Airborne drone disablement apparatus, comprising the entanglement device preceding of claim 1, and an intercept vehicle for transporting and deploying the entanglement device towards a propeller of an airborne drone.

9. The airborne drone disablement apparatus of claim 8, wherein the intercept vehicle is an intercept drone.

10. The airborne drone disablement apparatus of claim 8, wherein the intercept vehicle is a projectile.

11. The airborne drone disablement apparatus of claim 10, further comprising a launcher for launching the projectile.

12. Use of an entanglement device to disable a propeller of an airborne drone, wherein the entanglement device comprises a plurality of elongate filaments arranged as a tassel.

13. A method of disabling a propeller of an airborne drone, the method comprising the steps of:
a) Transporting to an airborne drone, an entanglement device comprising a plurality of elongate filaments arranged as a tassel; and then
b) Deploying the entanglement device at a propeller of the airborne drone; such that the propeller can be entangled, thereby disabling the airborne drone.
